(19) United States
(12) Patent Application Publication
(10) Pub. No.: US 2013/0286470 A1
(43) Pub. Date: Oct. 31, 2013

(54) INFRARED-CUT FILTER WITH SAPPHIRE SUBSTRATE AND LENS MODULE

(71) Applicants: SHIH-CHE CHIEN, Tu-Cheng (TW); JUIN-HONG LIN, Tu-Cheng (TW); CHAO-TSANG WEI, Tu-Cheng (TW)

(72) Inventors: SHIH-CHE CHIEN, Tu-Cheng (TW); JUIN-HONG LIN, Tu-Cheng (TW); CHAO-TSANG WEI, Tu-Cheng (TW)

(21) Appl. No.: 13/655,700

(22) Filed: Oct. 19, 2012

(30) Foreign Application Priority Data
Apr. 27, 2012 (TW) 101115058

(51) Int. Cl. G02B 5/28; G02B 7/02

(52) U.S. Cl. 359/359

(57) ABSTRACT

An IR-cut filter includes a substrate and a film. The substrate made of sapphire. The film is covered on the substrate and is configured for increasing reflectivity of infrared lights and filtering the infrared lights. The film includes a plurality of high refractive index layers and a plurality of low refractive index layers alternately stacked on the substrate. The refractive index of the high refractive index layers is greater than about 2.0, and the refractive index of the low refractive index layers is lower than about 1.5.

### BACKGROUND

1. Technical Field

The present disclosure relates to infrared-cut (IR-cut) filters, and particularly, to an IR-cut filter and a lens module including the IR-cut filter.

2. Description of Related Art

Sapphires have excellent hardness and wear-resistance, and are used in optics and machinery. The sapphire can be used as a cover glass to protect lenses received in a lens module. However, quality of images captured by the lens module may be affected by infrared light, as the sapphire transmits infrared light.

Therefore, it is desirable to provide an IR-cut filter and a lens module, which can overcome the limitations described.

### BRIEF DESCRIPTION OF THE DRAWINGS

FIG. 1 is a cross-sectional schematic view of an IR-cut filter in accordance with an exemplary embodiment.

FIG. 2 is a graph showing a spectrum characteristic curve of the IR-cut filter of FIG. 1.

FIG. 3 is a cross-sectional schematic view of a lens module using the IR-cut filter of FIG. 1.

### DETAILED DESCRIPTION

Embodiments of the disclosure will be described with reference to the drawings.

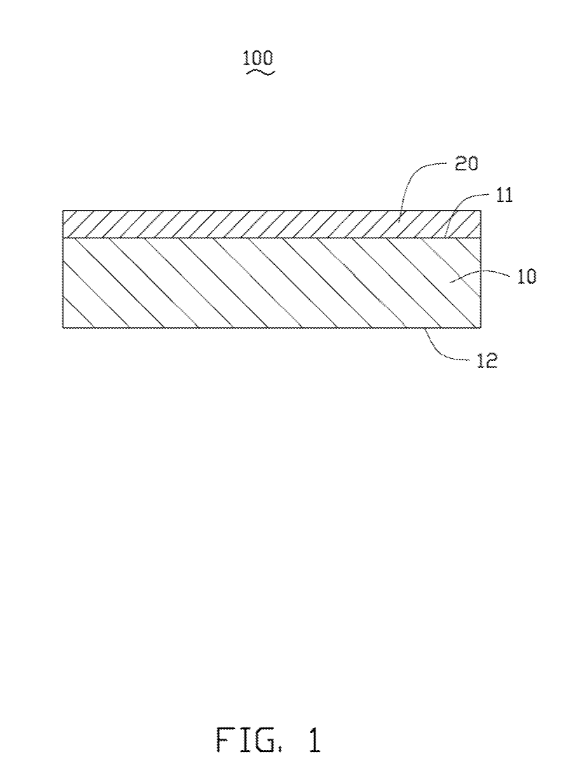

Referring to FIG. 1, an IR-cut filter 100, according to an exemplary embodiment is shown. The IR-cut filter 100 is configured to filter out (i.e., reject) infrared light and transmit (i.e., pass) visible light. The IR-cut filter 100 includes a substrate 10 and a film 20 formed on the substrate 10.

The substrate 10 is plate shaped and is made of sapphire. Sapphire is a gemstone variety of the mineral corundum, and has a hexagonal crystal structure. The main chemical component of sapphire is aluminum oxide, and the refractive index of the sapphire is from about 1.76 to about 1.78. A transmissivity of the substrate 10 at infrared wavelengths from about 825 nm to about 1300 nm is greater than 85%. The substrate 10 includes a first surface 11 and a second surface 12 opposite to the first surface 11.

The film 20 is configured to increase the reflectivity of the substrate 10 at the infrared lights, and is coated on the substrate 10 by a sputter method or an evaporation method. The film 20 includes a number of high refractive index layers and a number of low refractive index layers alternately stacked on the substrate 10. The refractive index of the high refractive index layer is greater than about 2.0, and the refractive index of the low refractive index layers is lower than about 1.5. In this embodiment, a material of the high refractive index layers can be selected from the group consisting of titanium dioxide (TiO₂), niobium pentoxide (Nb₂O₅), or tantalum pentoxide (Ta₂O₅), and a material of the low refractive index layers can be silicon dioxide (SiO₂).

The film 20 is comprised of about 60 to 70 layers. In this embodiment, the film 20 is stacked by a first layer to a seventieth layer in an order facing away from the first surface 11. The high refractive index layers are the odd number layers, and the low refractive index layers are the even number layers. The structure of the film 20 is (0.2 H, 0.3 L, 2 H, 0.3 L, 0.2 H, 2 L) (0.5 H) (0.2 L, 0.3 H, 2 L, 0.3 H, 0.2 L, 2 H) (2 L, 2 H)¹⁰ (0.2 L, 0.3 H, 2 L, 0.3 H, 0.2 L, 2 H)⁶ (1 L), wherein H represents as a quarter of thickness of a reference wavelength of the high refractive index layers, L represents as a quarter of thickness of a reference wavelength of the low refractive index layers, and the reference wavelength is about 463 nm.

In the embodiment, the film 20 is coated on the first surface 11 of the substrate 10. The material and thickness of each layer of the film 20 are shown in Table 1. The error of the optical thickness of each layer is ±0.01, and the error of the physics thickness of each layer is ±1.

TABLE 1

| | | | Physics Thickness |
|---|---|---|---|
| Layers | Material | Optical Thickness | (nm) |
| First layer | TiO₂ | 0.26 | 12 |
| Second layer | SiO₂ | 0.47 | 37 |
| Third layer | TiO₂ | 2.42 | 111 |
| Fourth layer | SiO₂ | 0.35 | 27 |
| Fifth layer | TiO₂ | 0.17 | 8 |
| Sixth layer | SiO₂ | 2.05 | 160 |
| Seventh layer | TiO₂ | 0.42 | 19 |
| Eighth layer | SiO₂ | 0.56 | 43 |
| Ninth layer | TiO₂ | 0.31 | 14 |
| Tenth layer | SiO₂ | 1.32 | 103 |
| Eleventh layer | TiO₂ | 0.17 | 8 |
| Twelfth layer | SiO₂ | 0.56 | 44 |
| Thirteenth layer | TiO₂ | 2.20 | 101 |
| Fourteenth layer | SiO₂ | 2.13 | 165 |
| Fifteenth layer | TiO₂ | 2.08 | 95 |
| Sixteenth layer | SiO₂ | 2.04 | 159 |
| Seventeenth layer | TiO₂ | 2.08 | 96 |
| Eighteenth layer | SiO₂ | 2.06 | 161 |
| Nineteenth layer | TiO₂ | 2.02 | 93 |
| Twentieth layer | SiO₂ | 2.06 | 160 |
| Twenty first layer | TiO₂ | 2.09 | 96 |
| Twenty second layer | SiO₂ | 2.05 | 159 |
| Twenty third layer | TiO₂ | 2.06 | 95 |
| Twenty fourth layer | SiO₂ | 2.10 | 163 |
| Twenty fifth layer | TiO₂ | 2.11 | 97 |
| Twenty sixth layer | SiO₂ | 2.07 | 161 |
| Twenty seventh layer | TiO₂ | 2.17 | 100 |
| Twenty eighth layer | SiO₂ | 2.25 | 175 |
| Twenty ninth layer | TiO₂ | 2.35 | 108 |
| Thirtieth layer | SiO₂ | 2.34 | 182 |
| Thirty first layer | TiO₂ | 2.43 | 112 |
| Thirty second layer | SiO₂ | 2.35 | 183 |
| Thirty third layer | TiO₂ | 2.30 | 106 |
| Thirty fourth layer | SiO₂ | 0.16 | 12 |
| Thirty fifth layer | TiO₂ | 0.17 | 8 |
| Thirty sixth layer | SiO₂ | 2.29 | 178 |
| Thirty seventh layer | TiO₂ | 0.56 | 25 |
| Thirty eighth layer | SiO₂ | 0.16 | 13 |
| Thirty ninth layer | TiO₂ | 2.00 | 92 |
| Fortieth layer | SiO₂ | 0.38 | 29 |
| Forty first layer | TiO₂ | 0.42 | 19 |
| Forty second layer | SiO₂ | 1.92 | 149 |
| Forty third layer | TiO₂ | 0.18 | 8 |
| Forty fourth layer | SiO₂ | 0.51 | 39 |
| Forty fifth layer | TiO₂ | 2.28 | 105 |
| Forty sixth layer | SiO₂ | 0.16 | 12 |
| Forty seventh layer | TiO₂ | 0.25 | 11 |
| Forty eighth layer | SiO₂ | 2.15 | 167 |
| Forty ninth layer | TiO₂ | 0.29 | 13 |
| Fiftieth layer | SiO₂ | 0.17 | 13 |
| Fifty first layer | TiO₂ | 2.24 | 103 |
| Fifty second layer | SiO₂ | 0.36 | 28 |
| Fifty third layer | TiO₂ | 0.28 | 13 |
| Fifty fourth layer | SiO₂ | 2.25 | 175 |
| Fifty fifth layer | TiO₂ | 0.33 | 15 |
| Fifty sixth layer | SiO₂ | 0.33 | 26 |
| Fifty seventh layer | TiO₂ | 2.30 | 106 |
| Fifty eighth layer | SiO₂ | 0.30 | 23 |
| Fifty ninth layer | TiO₂ | 0.31 | 14 |
| Sixtieth layer | SiO₂ | 1.99 | 155 |
| Sixty first layer | TiO₂ | 0.24 | 11 |
| Sixty second layer | SiO₂ | 0.35 | 27 |
| Sixty third layer | TiO₂ | 2.14 | 98 |
| Sixty fourth layer | SiO₂ | 0.20 | 15 |
| Sixty fifth layer | TiO₂ | 0.31 | 14 |
| Sixty sixth layer | SiO₂ | 1.97 | 153 |
| Sixty seventh layer | TiO₂ | 0.18 | 8 |
| Sixty eighth layer | SiO₂ | 0.31 | 24 |
| Sixty ninth layer | TiO₂ | 2.29 | 105 |
| Seventieth layer | SiO₂ | 1.17 | 91 |

In other embodiments, the high refractive index layer and the low refractive index layer can be other materials. The number of layers and the thickness of each layer can be designed according to actual requirement.

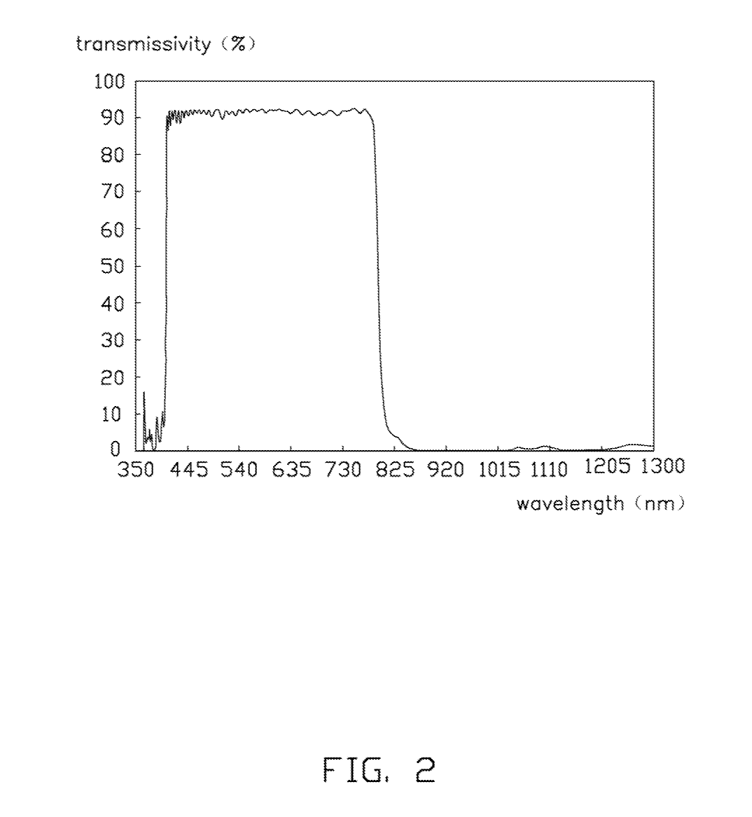

Referring to FIG. 2, a graph showing a spectrum of the IR-cut filter 100 is illustrated. The transmissivity of the substrate 10 at the infrared wavelengths from about 825 nm to about 1300 nm is lower than about 2%. The infrared lights are filtered after the lights passing through the IR-cut filter 100.

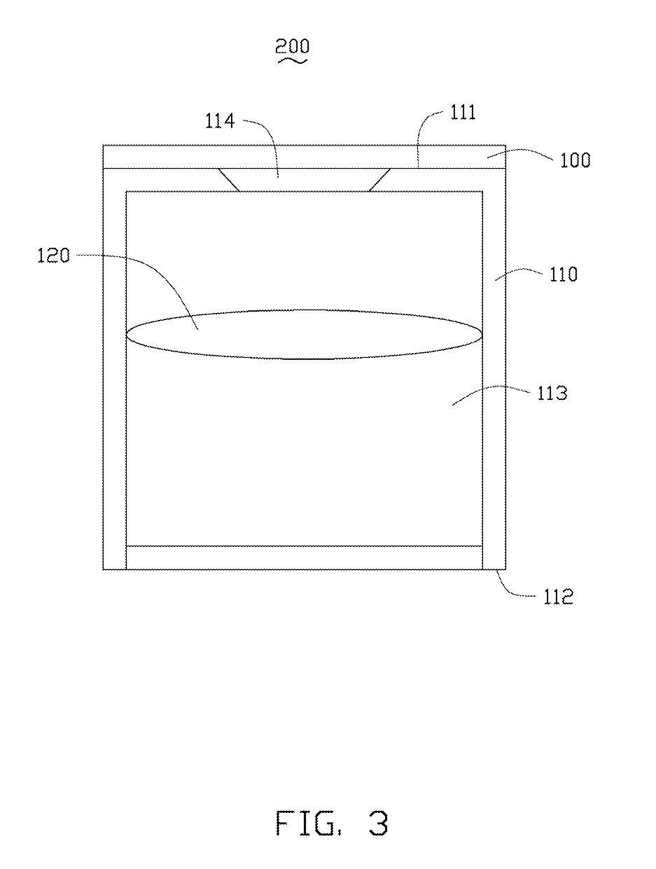

Referring to FIG. 3, a lens module 200, according to an exemplary embodiment, includes the IR-cut filter 100, a lens barrel 110, and at least one lens 120. The lens barrel 110 includes an object side 111 and an image side 112 opposite to the object side 111. A receiving room 113 is formed in the lens barrel 110 between the object side 111 and the image side 112. The lens barrel 110 defines a light entering hole 114 communicating with the receiving room 113 and positioned on the object side 111. The at least one lens 120 is received in the receiving room 113. The IR-cut filter 100 covers the object side 111, and the light entering hole 114 is sealed by the IR-cut filter 100. The IR-cut filter 100 not only can filter the infrared lights and transmit the visible light, but also can protect the lens module 200 from being damaged by an external force.

It should be understood that the IR-cut filter 100 can be received in the receiving room 113 or positioned on the image side 112 for filtering the infrared lights from the lights projected into the light entering hole 114.

Particular embodiments are shown and described by way of illustration only. The principles and the features of the present disclosure may be employed in various and numerous embodiments thereof without departing from the scope of the disclosure as claimed. The above-described embodiments illustrate the scope of the disclosure but do not restrict the scope of the disclosure.

What is claimed is:

1. An IR-cut filter, comprising:
a substrate made of sapphire; and
a film covered on the substrate and configured for increasing reflectivity of infrared lights and filtering the infrared lights; the film comprising a plurality of high refractive index layers and a plurality of low refractive index layers alternately stacked on the substrate, a refractive index of the high refractive index layers is greater than about 2.0, and a refractive index of the low refractive index layers is lower than about 1.5.

2. The IR-cut filter of claim 1, wherein a material of the high refractive index layers is selected from the group consisting of titanium dioxide (TiO₂), niobium pentoxide (Nb₂O₅), and tantalum pentoxide (Ta₂O₅), and a material of the low refractive index layers is silicon dioxide (SiO₂).

3. The IR-cut filter of claim 1, wherein the film is comprised of about 60 to 70 layers.

4. The IR-cut filter of claim 3, wherein the film is stacked by a first layer to a seventieth layer in an order facing away from the substrate.

5. The IR-cut filter of claim 4, wherein the structure of the film is (0.2 H, 0.3 L, 2 H, 0.3 L, 0.2 H, 2 L) (0.5 H) (0.2 L, 0.3 H, 2 L, 0.3 H, 0.2 L, 2 H) (2 L, 2 H)¹⁰ (0.2 L, 0.3 H, 2 L, 0.3 H, 0.2 L, 2 H)⁶ (1 L), wherein H represents as a quarter of thickness of a reference wavelength of the high refractive index layers, L represents as a quarter of thickness of a reference wavelength of the low refractive index layers, and the reference wavelength is about 463 nm.

6. A lens module, comprising:
a lens barrel comprising an object side and an image side opposite to the object side, the lens barrel defining a receiving room between the object side and the image side, the lens barrel defining a light entering hole communicating with the receiving room and positioned on the object side;
at least one lens received in the receiving room; and
an IR-cut filter covering the light entering hole, the IR-cut filter comprising:
a substrate made of sapphire; and
a film covered on the substrate and configured for increasing reflectivity of infrared lights and filtering the infrared lights; the film comprising a plurality of high refractive index layers and a plurality of low refractive index layers alternately stacked on the substrate, a refractive index of the high refractive index layers is greater than about 2.0, and a refractive index of the low refractive index layers is lower than about 1.5.

7. The lens module of claim 6, wherein a material of the high refractive index layers is selected from the group consisting of titanium dioxide (TiO₂), niobium pentoxide (Nb₂O₅), and tantalum pentoxide (Ta₂O₅), and a material of the low refractive index layers is silicon dioxide (SiO₂).

8. The lens module of claim 6, wherein the film is comprised of about 60 to 70 layers.

9. The lens module of claim 8, wherein the film is stacked by a first layer to a seventieth layer in an order facing away from the substrate.

10. The lens module of claim 9, wherein the structure of the film is (0.2 H, 0.3 L, 2 H, 0.3 L, 0.2 H, 2 L) (0.5 H) (0.2 L, 0.3 H, 2 L, 0.3 H, 0.2 L, 2 H) (2 L, 2 H)¹⁰ (0.2 L, 0.3 H, 2 L, 0.3 H, 0.2 L, 2 H)⁶ (1 L), wherein H represents as a quarter of thickness of a reference wavelength of the high refractive index layers, L represents as a quarter of thickness of a reference wavelength of the low refractive index layers, and the reference wavelength is about 463 nm.
